(19) United States
(12) Patent Application Publication
(10) Pub. No.: US 2010/0059215 A1
(43) Pub. Date: Mar. 11, 2010

(54) PLATE TYPE OIL COOLER

(75) Inventors: John A. Kolb, New Haven, CT (US); Arnold Marcus, Orange, CT (US)

Correspondence Address: LAW OFFICE OF DELIO & PETERSON, LLC., 121 WHITNEY AVENUE, 3RD FLLOR, NEW HAVEN, CT, 06510, US

(73) Assignee: PROLIANCE INTERNATIONAL INC., New Haven, CT (US)

(21) Appl. No.: 12/208,890

(22) Filed: Sep. 11, 2008

(51) Int. Cl. F28D 9/00; F28F 3/08; B23P 15/26

(52) U.S. Cl. 165/152; 165/167; 29/890.039

(57) ABSTRACT

An oil cooler for use in a motor vehicle radiator tank is made of a plurality of plate assemblies, each comprising a pair of plate shells. Each plate shell has opposite upstanding walls, and the plate shells are nested so that the upstanding walls are in contact and sealed along their peripheries. The plate shells have deformed walls forming serpentine passageways in thermally conductive communication with the plate shells to transfer heat from the oil, and deformed projections extending into the interior space in passageways cause turbulence in the oil. Fittings for passage of oil into and out of the oil cooler have a flange with a groove and an elastomeric gasket with an elliptical cross section to seal the fittings to the tank wall opening. The oil cooler is mounted within the tank so that it is located approximately equidistant from the front and rear tank walls.

### RELATED APPLICATION

This application is related to U.S. application Ser. No. [attorney docket no. PROL 100028000] for Composite Construction Oil Cooler Fitting filed on even date herewith.

### BACKGROUND OF THE INVENTION

1. Field of the Invention

The present invention relates to heat exchangers for automobiles and other motor vehicles and, in particular, to plate-type oil coolers used in combination with a radiator tank for the purpose of cooling automatic transmission fluid, engine oil or other fluids.

2. Description of Related Art

The automatic transmission of a typical automobile or light truck contains about ten quarts of automatic transmission fluid, which is used to operate the torque converter and the various valves, clutches and bands of the transmission. This fluid is also the only means of cooling the transmission. During operation, a portion of this fluid is routed to the transmission oil cooler located inside the outlet tank of the engine cooling radiator and cooled by the engine coolant. The flow to the oil cooler is in parallel with the flow to the transmission components, so that when more oil flows to the oil cooler, less flows to the transmission components, and vice-versa.

When radiators with copper/brass cores and brass tanks were common, most in-tank oil coolers were made of brass, in a concentric tube configuration. For those applications requiring higher oil cooler heat transfer performance than would be available from a typical brass concentric tube oil cooler, plate-type oil coolers made of brazed stainless steel would be supplied. The heat transfer performance of plate-type oil coolers could be tailored to meet the oil cooling requirements by adding plates as required. However, the stainless steel plate-type oil coolers were considerably more expensive than brass concentric tube oil coolers, and so were reserved for the more severe applications. With the advent of brazed aluminum radiators with plastic tanks, the construction of in-tank oil coolers at first remained the same using brass concentric tube type with stainless steel plate-type oil coolers being used in higher heat transfer applications.

Recent developments have led to a desire to replace the brass and stainless steel oil coolers with oil coolers made of aluminum. The price of copper, the major constituent of brass, has risen so high lately that brass concentric tube oil coolers are now just about as expensive as stainless steel plate-type oil coolers. An aluminum oil cooler, either of the concentric tube type or the plate type, will have a lower material cost than either a brass or stainless steel oil cooler. Additionally, having an aluminum oil cooler eliminates the electrolysis problems associated with having dissimilar metals, particularly brass, in the radiator tanks of brazed aluminum radiators. For these reasons, automobile manufacturers have been shifting to the use of aluminum oil coolers, both of the concentric tube and the plate type.

Aluminum oil coolers are not without their problems, however. The main problem is that aluminum fittings on aluminum oil coolers are very soft and subject to cross-threading of the mating attachments. In addition, where a different alloy of aluminum has been used for the fittings to make them somewhat harder than the alloy in the body of the brazed aluminum oil cooler, there have been oil cooler failures due to severe corrosion at the interface of the two different aluminum alloys. Another problem with aluminum oil coolers is the lower relative strength of aluminum compared to the other materials. Bulging of aluminum plate oil coolers has been observed. Some oil cooler manufacturers have designed aluminum plate-type oil coolers with outer stiffening members to prevent bulging under pressure. In the changeover from brass and stainless steel to aluminum, little has been done to improve the design of the oil cooler to optimize heat transfer performance. The new aluminum oil coolers look very much like their earlier brass and stainless steel counterparts.

What is needed is an in-tank oil cooler with superior heat transfer characteristics, made of either corrosion resistant steel or aluminum, that would provide for optimum performance at the least possible cost, that would be strengthened internally against bulging under pressure, that could be optimally located within the coolant tank, that would be less likely to leak at the radiator tank openings though which the oil cooler fittings pass, that would have fittings of a durable material which would be resistant to cross threading of attaching fittings, and that would not create a dissimilar metals corrosion problem between the fitting material and the oil cooler material.

### SUMMARY OF THE INVENTION

Bearing in mind the problems and deficiencies of the prior art, it is therefore an object of the present invention to provide an improved automotive oil cooler.

It is another object of the present invention to provide an oil cooler having improved heat transfer characteristics.

A further object of the present invention is to provide an oil cooler with increased strength to resist deformation and bulging of the plate shells.

A yet further object of the present invention is to provide an oil cooler which resists galvanic corrosion due to dissimilar metals within the radiator cooling fluid.

It is yet another object of the present invention to provide an oil cooler positioned within an automotive radiator for improved circulation of the engine coolant along the surfaces thereof.

It is still another object of the present invention to provide an oil cooler for an automotive radiator which provides improved pressure drop for better transmission shifting.

It is another object of the present invention to provide an oil cooler with an improved seal between the inlet/outlet fitting and the automotive radiator tank.

Still other objects and advantages of the invention will in part be obvious and will in part be apparent from the specification.

The above and other objects, which will be apparent to those skilled in the art, are achieved in the present invention which is directed to an oil cooler for use in a tank of a motor vehicle radiator. The oil cooler has at least one plate assembly comprising a pair of plate shells sealed along peripheries thereof to form an interior space. The interior space has walls forming at least one serpentine passageway for passage of oil to be cooled, wherein the walls of the passageway are in thermally conductive communication with the plate shells to transfer heat from the oil in the passageway to coolant when the oil cooler is immersed in coolant in the radiator tank.

In another aspect, the present invention is directed to a method of making an oil cooler for use in a tank of a motor vehicle radiator. The method includes providing a pair of plate shells, with at least one plate shell having walls for forming at least one serpentine passageway. The walls of the passageway are in thermally conductive communication with the at least one plate shell to transfer heat from the oil in the passageway to coolant when the oil cooler is immersed in coolant in the radiator tank. The method then includes assembling the pair of plate shells by sealing the shells along peripheries thereof and by sealing the walls of one plate shell to the other plate shell to form a plate assembly having an interior space between the shells. The walls after sealing form at least one serpentine passageway in the interior space for passage of oil to transfer heat from the oil in the passageway to coolant when the oil cooler is immersed in coolant in the radiator tank. Optionally the method includes adding at least one additional plate assembly to form an oil cooler.

Preferably, the walls are formed by deformation of at least one of the plate shells to form the at least one passageway through the interior space, and more preferably, the walls are formed by deformation of both plate shells to form the at least one passageway. The oil plate shells have a length and a width shorter than the length, and the at least one passageway may cause oil flow through the interior space in multiple passes either across the width of the plate shells or along the length of the plate shells. At least one plate shell is preferably deformed to form the walls forming the at least one serpentine passageway.

The oil cooler may further include projections from at least one plate shell extending into the interior space in the at least one passageway to cause turbulence in the oil passing therethrough.

The plate shells may be made of a material selected from the group consisting of AMP0336 aluminum alloy, 7072 aluminum alloy, 4343 aluminum alloy, 409 stainless steel and 430 stainless steel, or from an aluminized steel sheet clad on both sides with roll-bonded 4343 aluminum alloy.

In a further aspect, the present invention provides an oil cooler for use in a tank of a motor vehicle radiator. The oil cooler has at least one plate assembly comprising a pair of plate shells sealed along peripheries thereof to form an interior space for passage of oil to be cooled. At least one plate shell is deformed to provide projections extending into the interior space to cause turbulence in the oil passing therethrough and promote transfer of heat from the oil in the passageway through the plate shells to coolant when the oil cooler is immersed in coolant in the radiator tank. Preferably, both plate shells are deformed to provide projections extending into the interior space. The projections from one plate shell may contact the projections from the other plate shell to disrupt flow of oil through the interior space. Preferably, the projections from one plate shell are staggered from the projections from the other plate shell.

In yet another aspect, the present invention provides a method of making an oil cooler for use in a tank of a motor vehicle radiator comprising providing a pair of plate shells, at least one plate shell being deformed to provide projections extending therefrom, and assembling the pair of plate shells by sealing the shells along peripheries thereof to form a plate assembly having an interior space between the shells. The projections extend into the interior space to cause turbulence in the oil passing therethrough and promote transfer of heat from the oil in the passageway through the plate shells to coolant when the oil cooler is immersed in coolant in the radiator tank. The method optionally includes adding at least one additional plate assembly to form an oil cooler. Preferably, both plate shells are deformed to provide the projections.

Another aspect of the present invention is directed to a heat exchanger assembly comprising an oil cooler having fittings thereon for passage of oil into and out of the oil cooler, the oil cooler fittings each having a flange with a groove formed therein, the groove having a depth and a width between opposite walls, a heat exchanger tank having openings in a wall of the tank for passage of the fittings of the oil cooler, and an elastomeric gasket in the oil cooler flange groove. The gasket has an elliptical cross section in an undeformed state with a major diameter in the width direction of the groove and a minor diameter in the depth direction of the groove. The gasket is deformed by contact with the tank wall to fill essentially the entire region between the groove and the tank wall, thereby sealing the tank wall and opening to the oil cooler fitting.

A further aspect of the invention is directed to a method of assembling a heat exchanger manifold comprising providing an oil cooler having fittings thereon for passage of oil into and out of the oil cooler, the oil cooler fittings each having a flange with a groove formed therein, the groove having a depth and a width between opposite walls. The method also includes providing a heat exchanger tank having openings in a wall of the tank for passage of the fittings of the oil cooler. The method then includes placing in the flange groove an elastomeric gasket, the gasket having an elliptical cross section in an undeformed state with a major diameter in the width direction of the groove and a minor diameter in the depth direction of the groove. The method further includes mating the oil cooler to the tank by passing the fitting through the tank wall opening so that the tank wall contacts the elastomeric gasket, and deforming the gasket by contact with the tank wall to fill essentially the entire region between the groove and the tank wall and seal the tank wall and opening to the oil cooler fitting.

The present invention also provides an oil cooler for use in a tank of a motor vehicle radiator having at least one plate assembly comprising a pair of plate shells, each plate shell having opposite upstanding walls, with one plate shell having a smaller width between upstanding walls than the other plate shell. The plate shells are nested so that the upstanding walls are in contact and sealed along peripheries of the shells to form an interior space therebetween, with the width of the plate assembly being equal to the width of the shell having the larger distance over the plate shell upstanding walls. Preferably, the oil cooler is made of stainless steel. More preferably, the width of the plate assembly is from about 25 to 34 mm, and the oil cooler has a plurality of plate assemblies spaced apart from each other by at least 3 mm.

The present invention also is directed to an oil cooler for use in a tank of a motor vehicle radiator having at least two stacked plate assemblies, with each plate assembly comprising a pair of plate shells forming opposite top and bottom surfaces of each plate assembly. One plate assembly has a substantially smooth, planar bottom plate shell surface spaced from and facing a substantially smooth, planar top plate shell surface of the other plate assembly.

The present invention is directed in another aspect to a heat exchanger assembly comprising an oil cooler having fittings thereon for passage of oil into and out of the oil cooler; and a heat exchanger tank having front and rear walls, with openings in one tank wall through which the oil cooler fittings pass. The oil cooler is mounted within the tank so that the oil cooler is located approximately equidistant from the front and rear tank walls. Preferably, the oil cooler is located at least about 12 mm from each of the tank walls.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 is a partial exploded view of a plate, fin, outlet and upper outer stiffening member of a plate-type oil cooler.

FIG. 2 is a perspective view of the oil cooler shown in FIG. 1 after assembly.

FIG. 3 is a cross sectional side view of a plate-type oil cooler, inlet/outlet fitting, adapter and inlet/outlet line disposed in an automobile radiator tank according to the present invention.

FIG. 4 is a cross sectional side view of a plate-type oil cooler, a second embodiment of the inlet/outlet fitting, adapter and inlet/outlet line disposed in an automobile radiator tank according to the present invention.

FIG. 5 is a side sectional view of another embodiment of the inlet/outlet fitting showing an aluminum-coated carbon or stainless steel fitting as it is to be brazed to an aluminum oil cooler.

FIG. 5A is a side sectional view of the inlet/outlet fitting embodiment of FIG. 5 with a lower aluminum-coated flange for brazing to the oil cooler.

FIG. 6 is a side sectional view of a modification of the aluminum-coated composite fitting of FIG. 5, with only partial aluminum coating on the steel fitting.

FIG. 6A is a side sectional view of the inlet/outlet fitting embodiment of FIG. 6 with a lower aluminum-coated flange for brazing to the oil cooler.

FIG. 7 is a side sectional view of a further embodiment of the inlet/outlet fitting showing a steel sleeve having threads for connection to the oil line within an aluminum collar for brazing to an aluminum oil cooler.

FIG. 7A is a side sectional view of the inlet/outlet fitting embodiment of FIG. 7 with a lower aluminum flange for brazing to the oil cooler.

FIG. 8 is a modification of the inlet/outlet fitting of FIG. 7 wherein the steel sleeve extends entirely through the aluminum collar.

FIG. 8A is a side sectional view of the inlet/outlet fitting embodiment of FIG. 8 with a lower aluminum flange for brazing to the oil cooler.

FIG. 9 is a side sectional view of the preferred undeformed elliptical sealing gasket in the groove of the flange extending from the aluminum collar, before assembly.

FIG. 10 is a side sectional view of the deformed elliptical sealing gasket of FIG. 9, after assembly to the radiator tank.

FIG. 11 is a cross-sectional top view of a plate assembly in the plate-type oil cooler having multi-pass ribs according to the present invention.

FIG. 12 is a cross sectional elevational view of the plate assembly shown in FIG. 11, along lines 12-12.

FIG. 13 is a cross-sectional top view of an alternate embodiment of the multi-pass ribs of the plate assembly shown in FIG. 11.

FIG. 14 is a cross-sectional top view of another embodiment of the multi-pass ribs of the plate assembly shown in FIG. 11.

FIG. 15 is a cross-sectional top view of yet another embodiment of the multi-pass ribs of the plate assembly shown in FIG. 11.

FIG. 16 is a cross-sectional top view of the embodiment of the present invention shown in FIG. 11 with embossed dimples in the oil flow path.

FIG. 17 is a cross-sectional elevational view of the embossed dimples in FIG. 16, along lines 17-17.

FIG. 18 is a cross-sectional elevational view of an alternative embodiment of the embossed dimples in FIG. 16, showing staggered dimples.

FIG. 19 is a cross sectional view of a single plate assembly, across the width, showing the preferred upper and lower plate nesting of the present invention.

FIG. 20 is a side cross sectional side view of a plate-type oil cooler and inlet/outlet fitting without dimples or cooling fins between plate assemblies.

### DESCRIPTION OF THE PREFERRED EMBODIMENT(S)

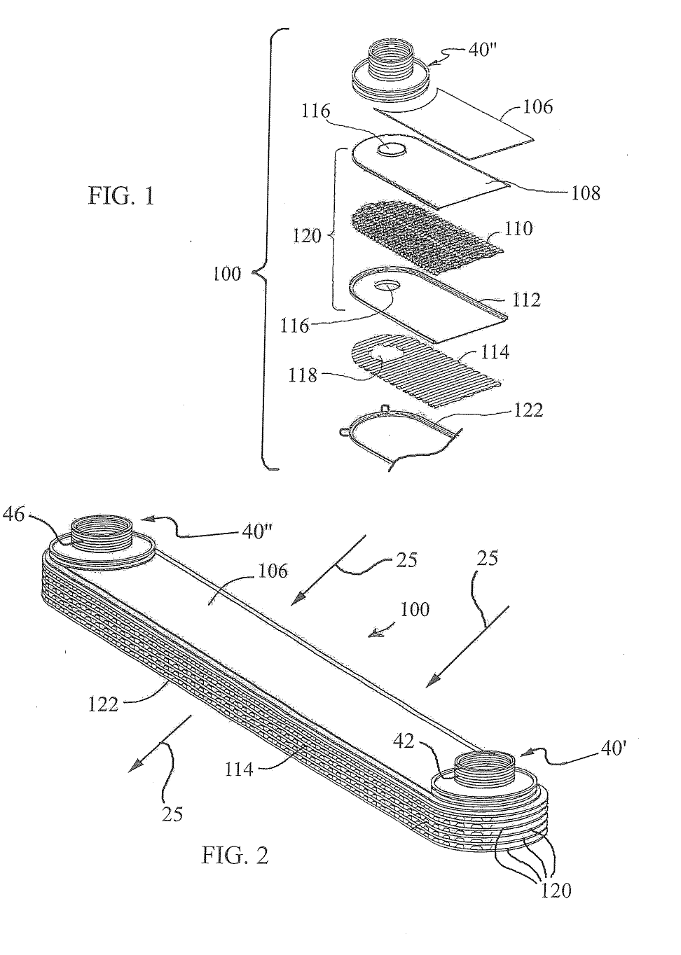

In describing the preferred embodiment of the present invention, reference will be made herein to FIGS. 1-20 of the drawings in which like numerals refer to like features of the invention.

To cool the oil from the motor vehicle engine or automatic transmission, a first aspect of the present invention employs a plate type oil cooler that is primarily made of aluminum for lower cost. The reference to oil as the liquid being cooled is intended to refer not only to automatic transmission fluid and engine oil as discussed above, but also to any liquid that is to be cooled by the oil cooler of the present invention.

As shown in FIGS. 1-4, a plate type oil cooler 100 has plates, turbulators and cooling fins made of aluminum. FIGS. 1 and 2 depict an otherwise conventional assembly of the oil cooler itself. Referring to FIG. 1, each plate assembly 120 has an inner turbulator 110 sandwiched between an upper plate 108 and a lower plate 112. The upper and lower plates are sealed along their respective peripheral edges by brazing so that oil may flow from an oil flow opening 116 having a lip at one end over, under and through the turbulator to a similar oil flow opening at the opposite end. A plurality of such plate assemblies 120 are stacked together with their oil flow openings aligned, as shown in FIG. 2. Between each pair of adjacent plate assemblies there is disposed a cooling fin 114 having an opening 118 to permit connection of the oil flow openings 116 of one plate assembly to the next. The upper and lower plates 108, 112 and the cooling fin 114 provide the surfaces to transfer heat between the oil and the external engine coolant. After the plate assemblies and cooling fins are stacked in sequence, outer stiffening members 106 and 122 may be provided at the upper and lower sides for structural stiffness.

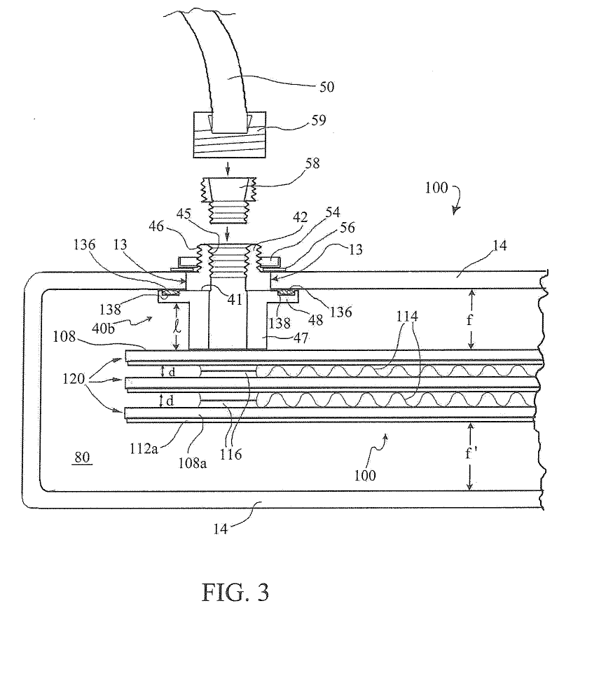

The oil cooler embodiments of the present invention preferably use composite aluminum/steel oil cooler inlet and outlet fittings such as those disclosed in co-pending U.S. application Ser. No. [attorney docket no. PROL 100028000] for Composite Construction Oil Cooler Fitting, the disclosure of which is hereby incorporated by reference. The novel composite aluminum/steel oil cooler inlet and outlet fittings 40′ and 40″ are then inserted in openings to create the assembly of the present invention. The outwardly-extending flange of fittings 40′, 40″ may be brazed to plate 108 to connect and seal the fitting to oil cooler 100. The entire assembly may be simultaneously brazed in a vacuum or controlled atmosphere brazing furnace to form the completed plate type oil cooler 100 as shown in FIG. 2. After installation in a coolant tank 14 (FIG. 3), oil then flows into the central opening in fitting 40′ and thereafter in parallel through the plate assemblies and exits through the central opening of fitting 40″. Engine coolant 25 flows through the cooling fins 114 between the plate assemblies. In one embodiment of the present invention, the cooling fins 114 are omitted, and heat is transferred directly from the oil through upper and lower plates 108, 112 to the engine coolant.

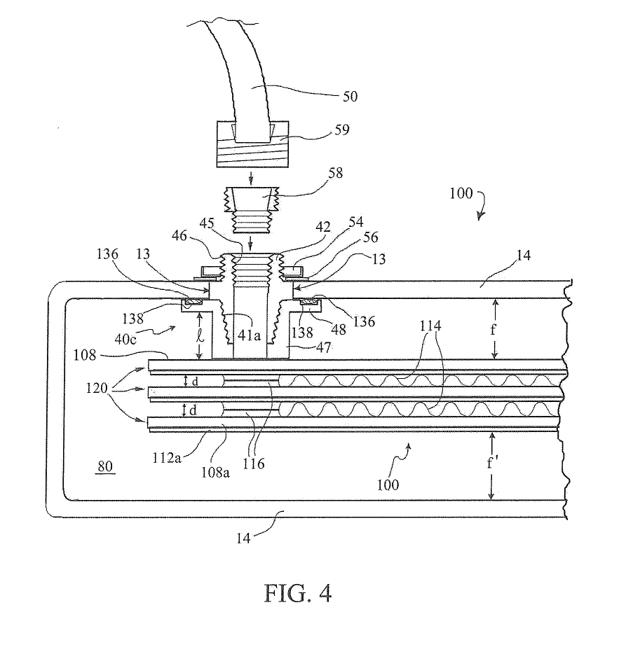

FIGS. 3 and 4 show the plate-type oil cooler 100 of the present invention attached through apertures 13 of a coolant tank 14 by attached inlet/outlet fittings 40b and 40c. The fittings used for the inlet and outlets in the present invention are substantially the same. FIGS. 3 and 4 show only one inlet/outlet fitting on one end of the oil cooler, and the other end of the oil cooler is identical. The coolant tank 14 additionally has inlet and outlet apertures (not shown) for liquid coolant 80 to flow in and out of the radiator tank.

The oil cooler 100 comprises a plurality of aluminum plate assemblies 120 stacked sealably leaving a distance d between adjacent plates (FIGS. 3 and 4). The oil cooler has an inlet fitting 40b (FIG. 3) or 40c (FIG. 4) and corresponding outlet fitting (not shown) adapted to removably connect the oil cooler to an inlet line 50 and corresponding outlet line (not shown). Internal threads 45 are shown on the inside of outer collar 42 which provide a coaxial connection for mating to a comparably threaded adapter 58, which then is threadingly connected to compression fitting 59 on the end of oil line 50. Alternately, the inlet/outlet line 50 may use the threaded fitting to thread directly into the internal threads 45 of the inlet/outlet fitting 40b or 40c. External threads 46 are provided on collar 42 so a nut 54 may be threaded thereon to secure the fitting within opening 13 of tank 14. A Palnut-type connector is commonly used as nut 54.

Fittings 40b, 40c extend through an aperture in the coolant tank 14 such that an oil to be cooled flows from the inlet line 50, through the inlet fitting, and is distributed into ends of the plate assemblies 120. After passing through the plate assemblies, the oil is collected and passed through the outlet fitting and out the outlet line. The inlet fitting has a collar 47 having a length I which locates the plate distances f, f′ from the opposite front and rear interior walls 14 of coolant tank 20. Preferably, oil cooler 100 is centered between the front and rear tank 20 walls, so that distance f is approximately equal to distance f′.

In FIG. 3, oil fitting 40b has a solid steel collar 42 friction welded to solid aluminum collar 47, preferably by spinning about the longitudinal axis of the fitting, to create a strong, solid state bonded aluminum/steel interface 41. In FIG. 4, the solid steel collar 42 of oil fitting 40c is connected to solid aluminum collar 47 by a tapered pipe thread connection 41a that may be disassembled. In both embodiments, the aluminum collar includes flange 48, and the internal 45 and external 46 steel fitting threads are uncoated.

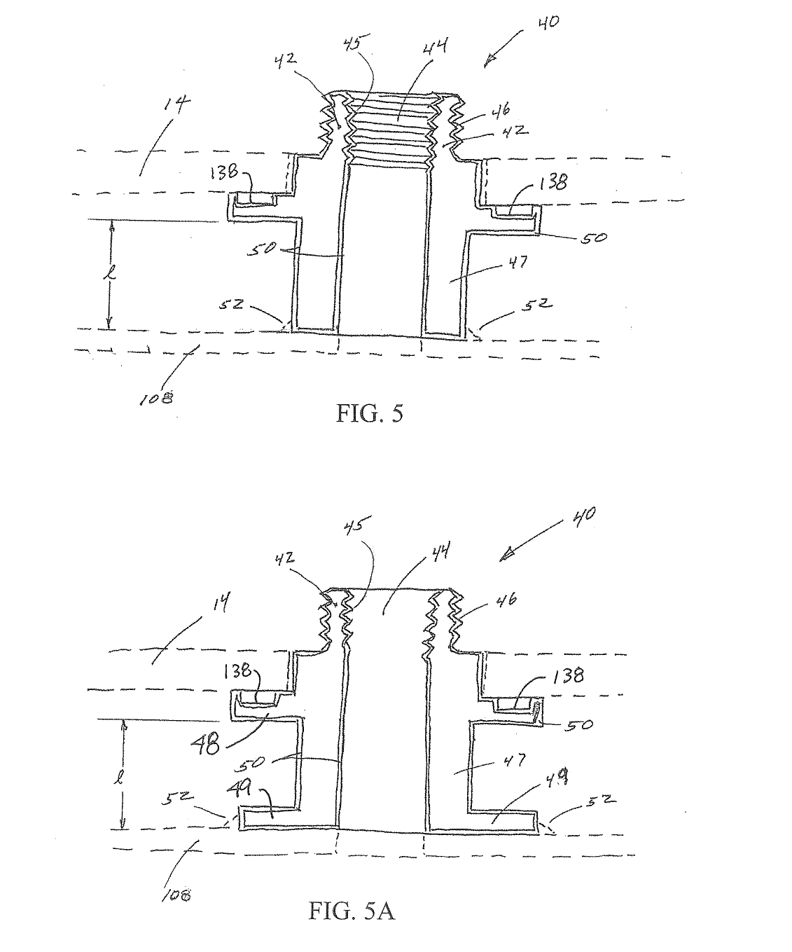

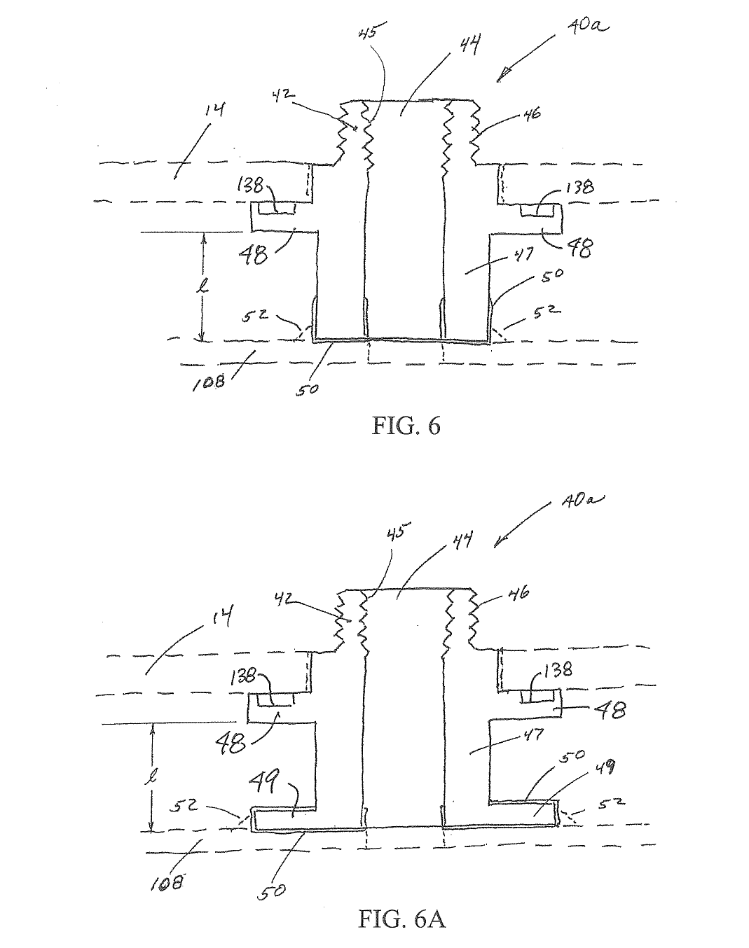

Alternative embodiments of the inlet/outlet fitting are shown in FIGS. 5, 5A, 6 and 6A. In FIG. 5, machined steel fitting 40 is coated with a layer of aluminum 50 before being brazed to the oil cooler assembly. The fitting may be coated by vacuum deposition, hot dip or by metal spray methods, either all over or only on the portions of the fitting that will be brazed. The lower end of collar 47 may be secured by brazing 52 to oil cooler plate 108. In FIG. 5A, collar 47 has a lower, outwardly extending flange portion 49 that may be secured by brazing to the oil cooler plate. The coating thicknesses for the vacuum deposited aluminum, hot dipped aluminum or metal sprayed aluminum should be such so as to permit sufficient brazing bonding strength with the oil cooler.

FIGS. 6 and 6A show partially coated embodiments 40a of the composite oil fitting of FIGS. 5 and 5A, respectively. In these embodiments, the inner 45 and outer 46 steel threads (along with the remaining inner bore 44 of the fitting 40a) are not coated with aluminum. The flange 49 surfaces and the outer surfaces of inner collar 47 have the aluminum coating 50 to permit brazing 52 to the oil cooler housing plate 108.

The inlet/outlet fitting 40, 40a, 40b, 40c has an upper collar 42 preferably made from stainless steel, which is less susceptible to thread damage than aluminum. All of the lower collar 47 in contact with the liquid coolant 80 in the tank is made from or coated with aluminum, and no steel is in contact with the coolant. This provides for a corrosion resistant interface with the aluminum oil cooler, since the coolant would otherwise cause galvanic corrosion to dissimilar metals at the oil cooler and inlet/outlet fitting interface if some portion of the steel surface were also in contact with the coolant. The inlet/outlet fittings 40, 40a 40b, 40c have an outwardly extending flange 48 which includes a groove 138 in which an elastomeric ring seal 136 having an elliptical cross section (in the undeformed state) may be inserted to seat against the inside surface of the coolant tank 14. This configuration provides a leak-tight seal, which prevents coolant 80 from leaking to outside the tank or corroding the junction of the upper portion and the lower portion of the inlet/outlet fittings 40b, 40c.

The length l of inner collar 47 is selected so that minimum distances f and f′ (FIGS. 3 and 4) of the oil cooler from the coolant tank 14 is at least about 0.5 in. (12.3 mm). This minimum distance f, f′ allows for improved circulation of the coolant 80 along all surfaces of the oil cooler 100, resulting in better cooling performance.

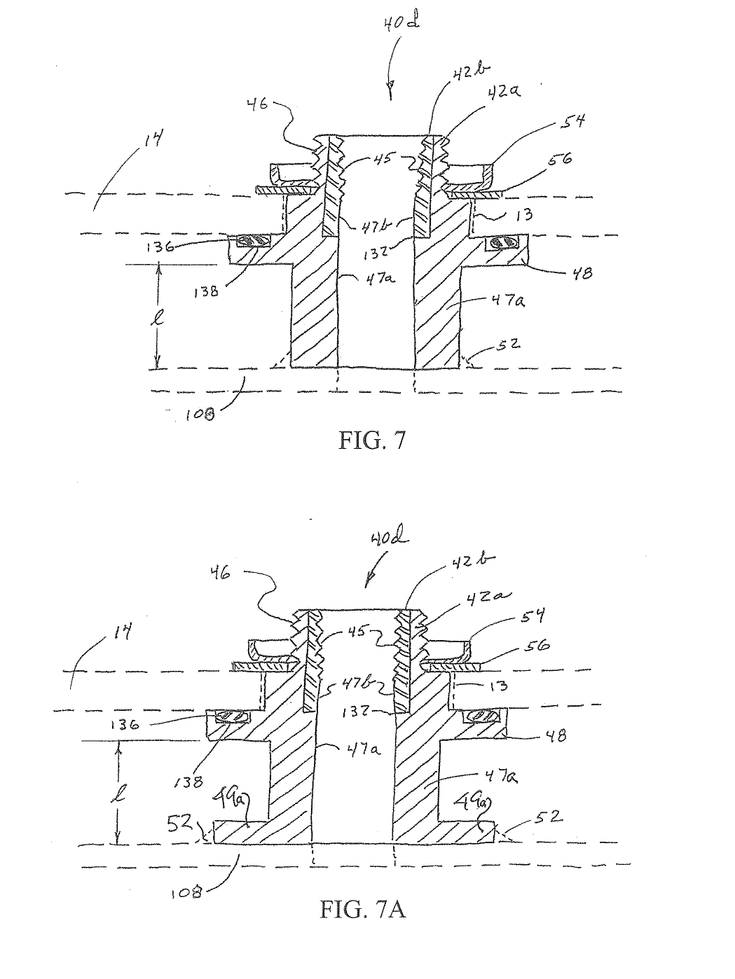

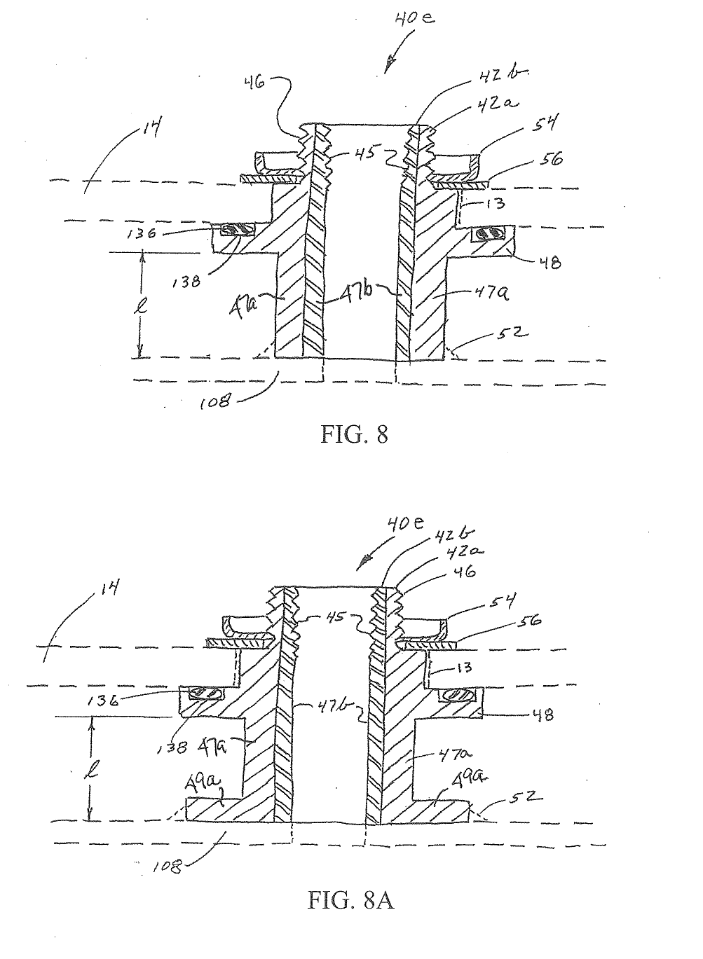

FIGS. 7, 7A, 8 and 8A depict modifications of the inlet/outlet fitting shown in FIGS. 3 and 4, wherein the steel portion of the fitting comprises a stainless steel sleeve fitted and brazed within an aluminum collar. In both inlet outlet fittings 40d, 40e of FIGS. 7, 7A, 8 and 8A, respectively, the steel sleeve includes an outer collar portion 42b having threads 45 on the inner surface for mating with a fitting of an oil line and an inner collar portion 47b. The aluminum portion of the inlet/outlet fitting includes an outer collar portion 42a having threads on the external surface for enabling a nut 54 to secure the fitting (and the oil cooler) to tank 14 through opening 13 using washer 56. The aluminum collar also includes an inner collar portion 47a which has an outwardly extending upper flange 48 for sealing to the wall 14 of the tank. The steel fitting is sized to create a tight coaxial fit within the aluminum collar sufficient to permit the two to be brazed together. In FIGS. 7 and 7A, the lower end of aluminum inner collar 47a extends below the steel collar, and includes an inwardly extending shoulder 132 against which the lower end of steel inner collar 47b abuts. In FIG. 7, the lower end of aluminum collar 47a may be secured by brazing 52 to oil cooler plate 108. In FIG. 7A, collar 47a has a lower, outwardly extending aluminum flange portion 49a that may be secured by brazing to the oil cooler plate. In FIGS. 8 and 8A, the lower end of steel inner collar 47b extends substantially the same distance as the aluminum collar to the oil cooler plate housing 108. In FIG. 8, the lower end of aluminum collar 47a may be secured by brazing 52 to oil cooler plate 108. In FIG. 8A, again collar 47a has lower, outwardly extending aluminum flange portion 49a that may be secured by brazing to the oil cooler plate. Both fitting embodiments 40d and 40e have hard steel threads for connection to the oil line fitting, aluminum flanges for sealing to the radiator tank and lower collars for brazing to the aluminum oil cooler body.

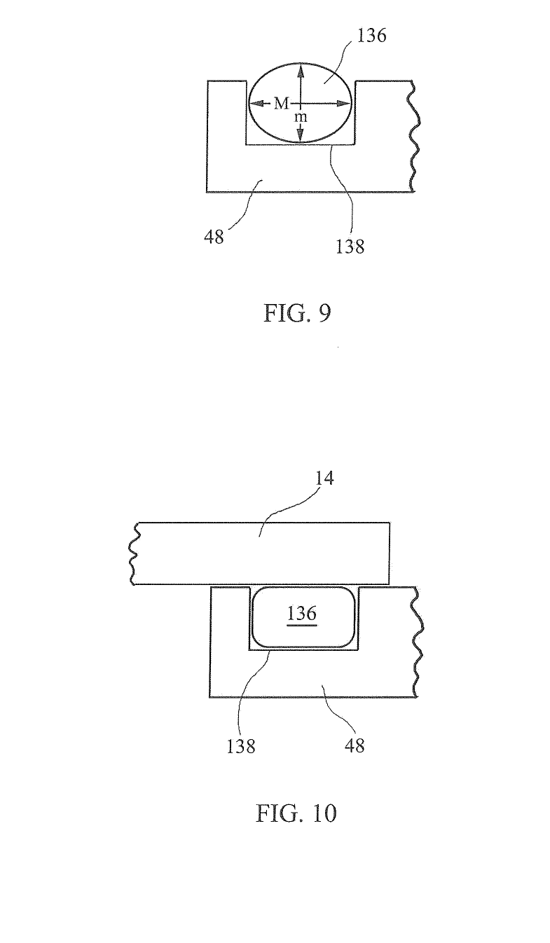

As in the fittings of FIGS. 3 and 4, flange 48 includes a circular groove 138 on an upper surface thereof which permits use of a continuous ring-type elastomeric gasket 136 to seal against the lower (inner) side of the wall of tank 14. To eliminate gasket deterioration under high coolant operating temperatures and to provide optimum sealing, gasket 136 is preferably made of EPDM rubber in an elliptical cross section when in the undeformed state. As shown in FIG. 9, the major diameter M of the gasket elliptical cross-section is disposed in the direction of the width of the groove, and the minor diameter m of the gasket elliptical cross-section is disposed in the direction of the depth of the groove. Because of the general incompressibility of rubber, the seal is designed with an elliptical cross section to insure that the void between the tank wall and the header groove becomes essentially completely filled by the rubber when the gasket is deformed between the tank wall and the groove side and bottom walls during assembly. As nut 54 is tightened (FIGS. 7 and 8), the tank 14 wall is forced down against the top of elliptical gasket 136 toward the bottom surface of groove 138. These forces cause the elliptical gasket to be deformed so that the gasket fills essentially the entire region between the groove lower surface and side walls and the tank wall, as shown in FIG. 10. Minor spaces may still be present around corner areas of the gasket after deformation. Sealing stress is created as the rubber pushes out radially against the constraining surfaces. The gasket loading creates a hydraulic lock with the flange 48 groove. The gasket material and elliptical shape load the incompressible elastomeric gasket material in such a way that minimizes the long term effects of gasket relaxation, squeeze-out, permanent deformation and chemical effects.

The oil coolers described in this first aspect of the present invention are preferably constructed of corrosion resistant aluminum materials as disclosed in U.S. patent application Ser. No. 11/769,343, the disclosure of which is hereby incorporated by reference. The oil cooler plates or shells 108, 112 are preferably made with a core alloy of AMP 0336, an aluminum alloy containing copper and titanium that provides a secondary corrosion-inhibiting characteristic. The outside of the plates are preferably coated with 7072 alloy, a zinc-rich aluminum alloy which provides sacrificial anodic protection to the core alloy, thereby limiting the cooling fluid 80 contact with the core alloy. If the primary corrosion defense of the 7072 alloy is breached, the AMP 0336 core alloy has the unique property of directing the corrosion along the length of the plate or shell, rather than through it, thereby prolonging the life of the plate or shell before failure. The inside of each plate or shell is preferably clad with 4343 aluminum brazing alloy, for brazing to its mating plate or shell.

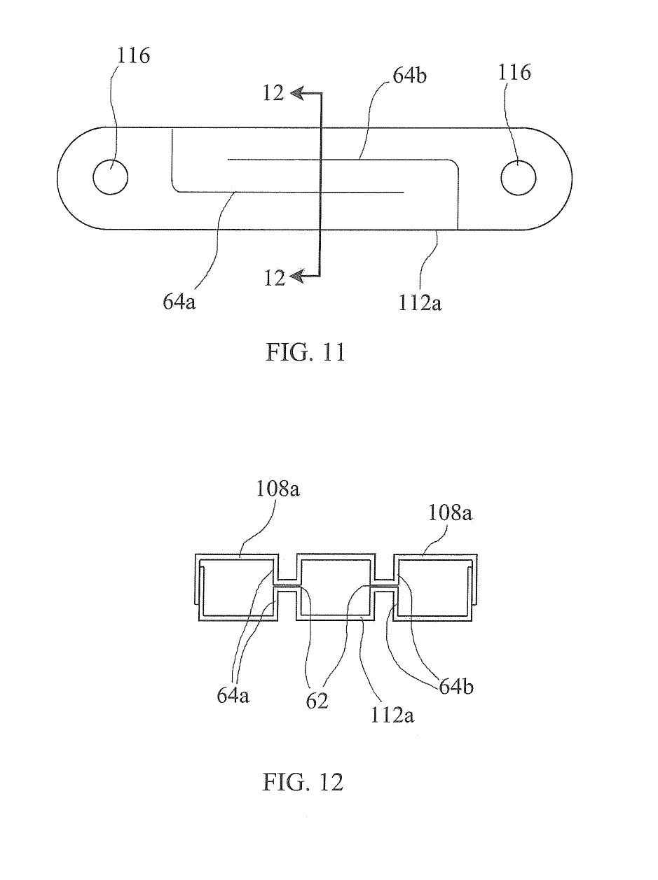

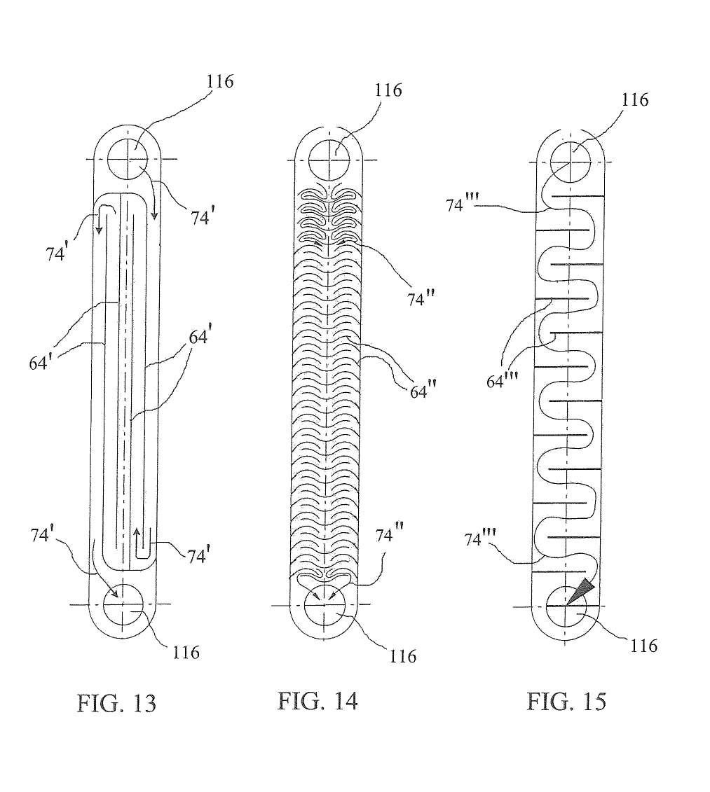

To extend the oil cooling path length, FIGS. 11 and 12 show each plate or shell 108a, 112a in the plate assembly pair embossed with corresponding and contacting walls or ribs 64a, 64b to form multiple passageways within each plate pair. The ribs may be formed separately or integrally with one or both of the plate shells, and are preferably deformed or embossed into the plate shell, so that the walls are in good thermally conductive communication with the plate shells. After the plates are nested together, these ribs are brazed to each other to form leak-free fluid passageway walls. FIG. 11 illustrates a serpentine three-pass plate configuration in which the passageway causes the oil to make multiple passes along the length of the plate assembly and FIG. 12 shows a cross sectional view of the embossed ribs of the two shells which make up the plate brazed together along the points of contact 62 to form leak-free fluid passageway walls. The brazed ribs 64a, 64b, of nesting plates 108a, 112a may additionally increase plate integrity by providing addition reinforcement against bulging. FIGS. 13-15 show three alternate embodiments of the multi-pass plate configuration whereby the oil flow is determined by patterns of rib 64′, 64″, and 64′″, respectively, which form serpentine passageways. The oil has a flow pattern as in FIGS. 13-15 indicated by the flow arrows 74′, 74″, and 74′″, respectively, through the oil cooler, so that the passageways in FIG. 13 causes the oil to make multiple passes along the length of the plate assembly and the passageways in FIGS. 14 and 15 causes the oil to make multiple passes along the width of the plate assembly.

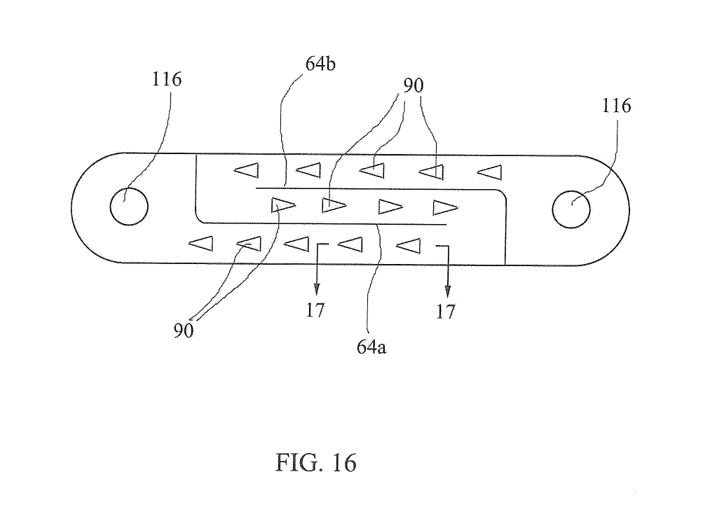

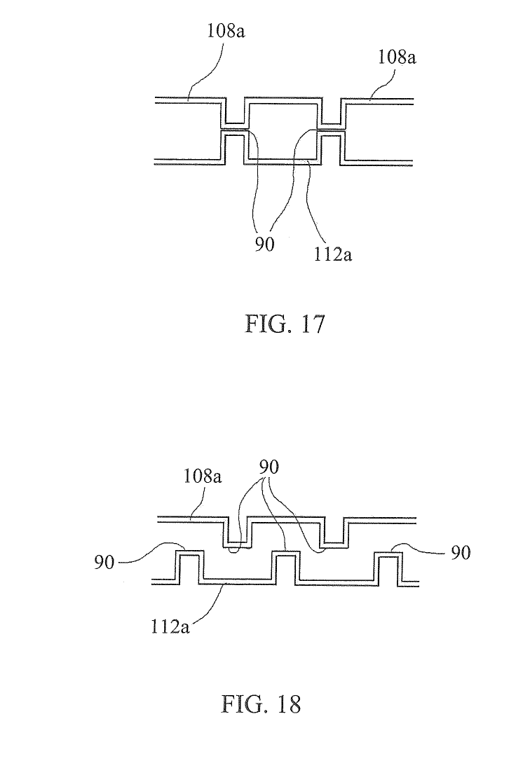

As an alternative to a separate lanced offset or other turbulator in the fluid passages between the nested plates, projections such as dimples of various shapes may be incorporated by deformation or embossment of the plate shells to provide turbulation. FIG. 16 shows turbulating projections 90 having a triangular shape within the oil flow path created by ribs 64a, 64b. Projections 90 of both nesting plate shells 108, 112 may be brazed where they contact each other (FIG. 17), or the projections may be staggered without contacting those of the other plate shell (FIG. 18). The projections may be used without the additional oil passages created by ribs 64a, 64b, and may have alternative shapes such as circular, square, or other geometrical shape. The projections promote transfer of heat from the oil in the passageway through the plate shells to coolant when the oil cooler is immersed in coolant in the radiator tank.

In another aspect, the plate-type oil cooler of the present invention may be made using steel instead of the aluminum construction described above. Referring back to FIGS. 1-4, the plate-type oil cooler depicted therein may be made from lower cost type 409 or type 430 stainless steel, instead of using a high-nickel type 304 stainless steel as preferred in prior art stainless steel oil coolers, with no sacrifice in corrosion resistance, durability or heat transfer performance. Furthermore, the turbulators 114 within the oil cooler plates may be made of even less expensive plain carbon steel, as they will always be immersed in oil during service and therefore will not be subject to corrosion. While typical prior art plate-type transmission oil coolers use plates of about 44 mm width, the preferred stainless steel plate-type transmission oil cooler of this invention employs narrower plates ranging in width w from about 25 to 34 mm (FIG. 1). Moreover, the stainless steel oil cooler of the present invention may be constructed with no more than three or four plate assemblies 120, when made in accordance with the preferred embodiment described herein. Despite its smaller size, the result is a plate-type oil cooler that provides sufficient heat transfer capability at typical transmission oil flow rates of up to about 2 gal./min (7.6 l/min.)

For improved coolant flow and heat transfer, the spacing between the plates of the oil cooler are preferably increased from the current practice of about 2.0 mm to about 3.0 mm or more, in order to achieve Hydraulic Diameter and Reynolds Number values that optimize coolant flow velocity through and around the oil cooler plates. To further enhance the heat transfer performance of the stainless steel oil cooler, the oil cooler body should be spaced away from the radiator tank wall in order to provide for improved coolant flow around the oil cooler. As shown in FIGS. 3 and 4, the distances f and f′ are preferably selected to be approximately the same, so that the oil cooler body is positioned approximately in the center of the radiator tank, from back to front, to insure coolant flow contact with the plates as the coolant exits the radiator core tubes. This may be accomplished by longer-than-usual inlet and outlet fittings. The increased spacing between plates and position of the oil cooler in the center of the tank insures optimum coolant velocity between the plates for optimum thermal performance without the use of a baffle to divert the water flow into the oil cooler from the core tubes.

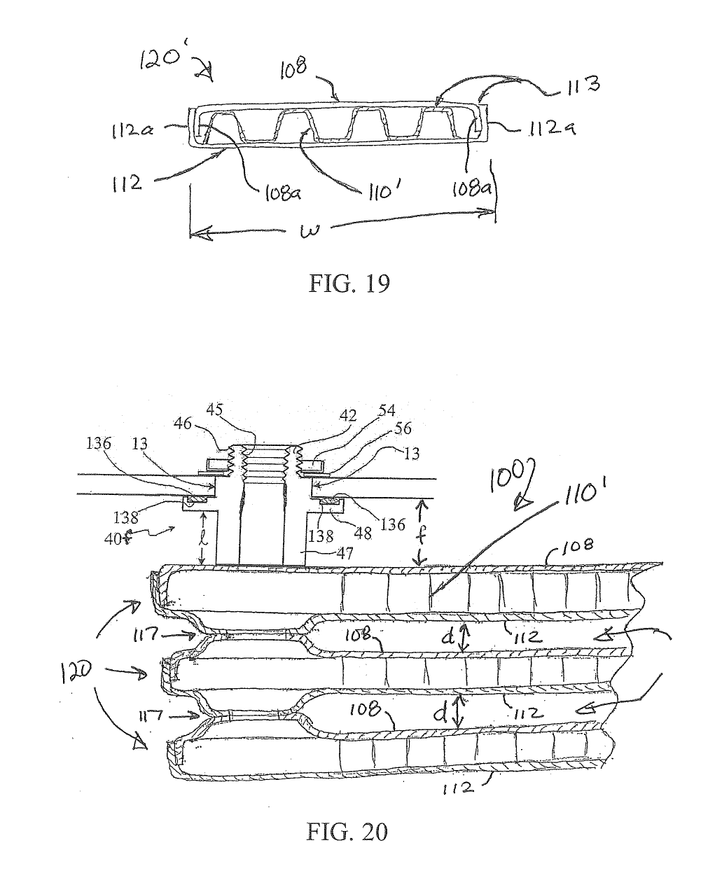

Instead of using a protruding lip construction for brazing around each plate of the plate assembly, as shown in FIG. 19 the plate shells are preferably U-shaped, with lower plate 112 having a pair of opposite upstanding walls 112a, and upper plate having a pair of upstanding walls 108a of slightly smaller width, so that the upper plate nests inside the lower plate (or vice-versa) to form an interior space therebetween. The width w of the plate assembly 120 is then the distance between the outer surfaces of the plate shell 112 having the larger width between the opposite upstanding walls 112a. The nesting plate shells and turbulator are brazed together along their contacting surfaces, e.g., contacting surfaces 113. The nesting plate shells eliminate the protruding brazing lip and provide more useful heat transfer width w, for a given overall width, than current typical plates. Therefore, in reducing the width of the oil cooler plates as compared to prior art plates, the resulting percentage reduction in heat transfer performance will be less than the percentage reduction in overall plate width.

The preferred stainless steel oil cooler also eliminates the use of externally projecting dimples from the plate assemblies often found in prior art oil coolers, primarily for manufacturing reasons, to aid in the stacking assembly of the plate assemblies. In prior art oil coolers, these dimples make brazing contact from plate assembly to plate assembly and provide structural strength to resist internal oil pressure. As shown in FIG. 20, plate assemblies 120 are stacked and spaced apart by distance d, and the surfaces of the facing plate shells 108, 112 are substantially smooth and planar, and free of dimples, cooling fins or other structures between them. Plate-to-plate brazing at the oil connections 117 may be accomplished by copper brazing rings placed between the adjacent plate assemblies. Additionally, instead of the turbulator 110′ configuration shown in FIGS. 19 and 20, any of the interior passageway configurations described above in connection with FIGS. 11-18 may be used. Structural strength against internal oil pressure is obtained by the brazing together of the embossments of mating plate shells. In the case of a stainless steel oil cooler, conventional fittings 40f, dimensionally similar to fittings shown in FIGS. 3 through 8A, but made entirely of type 409 or type 430 stainless steel instead of the composite steel/aluminum construction, may be used.

In another embodiment, an aluminum-bonded, aluminized carbon or stainless steel may be used for the oil cooler of the present invention. Examples of such materials are disclosed in U.S. patent publication no. 2008/0099183, the disclosure of which is hereby incorporated by reference, wherein a carbon steel sheet is covered on both sides with a hot dipped aluminum coating and then roll bonded on both sides to sheets of aluminum alloy with good brazing characteristics. An example of the latter is 4343 aluminum brazing alloy. Other aluminum alloys that may be bonded in place of or in addition to the 4343 alloy are 3003 aluminum alloy as a base and 7072 and AMP 0336 aluminum alloys for corrosion resistance. Aluminized 409 or other grade stainless steel may also be used in place of the aluminized carbon steel. The bonding between the aluminized steel and aluminum sheets is performed by preheating the sheets to about 315° C. and then rolling them together between rolls of a rolling mill in successive reductions of about 2% and 13%, respectively. The resulting aluminum-clad carbon or stainless sheet material provides the oil cooler with the strength of steel and the good brazing characteristics of aluminum.

Thus, the present invention achieves the objects described above by providing in one aspect an in-tank oil cooler that is made of aluminum or aluminum clad steel for compatibility with brazed aluminum radiators, that eliminates problems of dissimilar metals encountered with brass or stainless steel oil coolers, and that provides improved sealing between the fitting and the tank opening through which they pass. The present invention also achieves the objects described above by providing in another aspect an in-tank oil cooler that is made of stainless steel. The oil cooler of the present invention, whether made of aluminum or steel, has superior heat transfer performance as a result of a multi-passing configuration and optional turbulation which permits a reduction in the number of plates required to achieve needed performance. Internal stiffening resulting from the brazing together of the fluid path embossments in the plate shells eliminates the need for external stiffening of the oil cooler against bulging due to internal pressure. The oil cooler according to the present invention also has a higher oil pressure drop compared to conventional prior art stainless steel plate-type oil coolers, which improves the action of transmission shifting by reducing oil cooler flow and correspondingly increasing transmission oil flow. The oil cooler according to the present invention cools the transmission fluid better than conventional oil coolers, thereby increasing the life of the transmission and the transmission fluid.

While the present invention has been particularly described, in conjunction with specific preferred embodiments, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. An oil cooler for use in a tank of a motor vehicle radiator having at least one plate assembly comprising a pair of plate shells sealed along peripheries thereof to form an interior space, the interior space having walls forming at least one serpentine passageway for passage of oil to be cooled, the walls of the passageway being in thermally conductive communication with the plate shells to transfer heat from the oil in the passageway to coolant when the oil cooler is immersed in coolant in the radiator tank.

2. The oil cooler of claim 1 wherein the walls are formed by deformation of at least one of the plate shells to form the at least one passageway through the interior space.

3. The oil cooler of claim 1 wherein the walls are formed by deformation of both plate shells to form the at least one passageway through the interior space.

4. The oil cooler of claim 1 wherein the plate shells have a length and a width shorter than the length, and wherein the at least one passageway causes oil flow through the interior space in multiple passes across the width of the plate shells.

5. The oil cooler of claim 1 wherein the plate shells have a length and a width shorter than the length, and wherein the at least one passageway causes oil flow through the interior space in a multiple passes along the length of the plate shells.

6. The oil cooler of claim 2 wherein at least one plate shell is deformed to form the walls forming the at least one serpentine passageway.

7. The oil cooler of claim 1 further including projections from at least one plate shell extending into the interior space in the at least one passageway to cause turbulence in the oil passing therethrough.

8. The oil cooler of claim 1 wherein the plate shells are made of a material selected from the group consisting of AMP0336 aluminum alloy, 7072 aluminum alloy, 4343 aluminum alloy, 409 stainless steel and 430 stainless steel.

9. The oil cooler of claim 1 wherein the plate shells are made of an aluminized steel sheet clad on both sides with roll-bonded 4343 aluminum alloy.

10. A method of making an oil cooler for use in a tank of a motor vehicle radiator comprising:
providing a pair of plate shells, at least one plate shell having walls for forming at least one serpentine passageway, the walls of the passageway being in thermally conductive communication with the at least one plate shell to transfer heat from the oil in the passageway to coolant when the oil cooler is immersed in coolant in the radiator tank;
assembling the pair of plate shells by sealing the shells along peripheries thereof and by sealing the walls of one plate shell to the other plate shell to form a plate assembly having an interior space between the shells, the walls after sealing forming at least one serpentine passageway in the interior space for passage of oil to transfer heat from the oil in the passageway to coolant when the oil cooler is immersed in coolant in the radiator tank;
optionally adding at least one additional plate assembly to form an oil cooler.

11. The method of claim 10 wherein the walls are formed by deformation of at least one of the plate shells to form the at least one passageway through the interior space.

12. The method of claim 11 wherein the walls are formed by deformation of both plate shells to form the at least one passageway through the interior space.

13. An oil cooler for use in a tank of a motor vehicle radiator having at least one plate assembly comprising a pair of plate shells sealed along peripheries thereof to form an interior space for passage of oil to be cooled, at least one plate shell being deformed to provide projections extending into the interior space to cause turbulence in the oil passing therethrough and promote transfer of heat from the oil in the passageway through the plate shells to coolant when the oil cooler is immersed in coolant in the radiator tank.

14. The oil cooler of claim 13 wherein both plate shells are deformed to provide projections extending into the interior space.

15. The oil cooler of claim 14 wherein the projections from one plate shell contact the projections from the other plate shell to disrupt flow of oil through the interior space.

16. The oil cooler of claim 14 wherein the projections from one plate shell are staggered from the projections from the other plate shell.

17. A method of making an oil cooler for use in a tank of a motor vehicle radiator comprising:
providing a pair of plate shells, at least one plate shell being deformed to provide projections extending therefrom;
assembling the pair of plate shells by sealing the shells along peripheries thereof to form a plate assembly having an interior space between the shells, the projections extending into the interior space to cause turbulence in the oil passing therethrough and promote transfer of heat from the oil in the passageway through the plate shells to coolant when the oil cooler is immersed in coolant in the radiator tank;
optionally adding at least one additional plate assembly to form an oil cooler.

18. The method of claim 17 wherein both plate shells are deformed to provide the projections.

19. A heat exchanger assembly comprising:
an oil cooler having fittings thereon for passage of oil into and out of the oil cooler, the oil cooler fittings each having a flange with a groove formed therein, the groove having a depth and a width between opposite walls;
a heat exchanger tank having openings in a wall of the tank for passage of the fittings of the oil cooler;
an elastomeric gasket in the oil cooler flange groove, the gasket having an elliptical cross section in an undeformed state with a major diameter in the width direction of the groove and a minor diameter in the depth direction of the groove, the gasket being deformed by contact with the tank wall to fill essentially the entire region between the groove and the tank wall, thereby sealing the tank wall and opening to the oil cooler fitting.

20. A method of assembling a heat exchanger manifold comprising:
providing an oil cooler having fittings thereon for passage of oil into and out of the oil cooler, the oil cooler fittings each having a flange with a groove formed therein, the groove having a depth and a width between opposite walls;
providing a heat exchanger tank having openings in a wall of the tank for passage of the fittings of the oil cooler;
placing in the flange groove an elastomeric gasket, the gasket having an elliptical cross section in an undeformed state with a major diameter in the width direction of the groove and a minor diameter in the depth direction of the groove;
mating the oil cooler to the tank by passing the fitting through the tank wall opening so that the tank wall contacts the elastomeric gasket; and
deforming the gasket by contact with the tank wall to fill essentially the entire region between the groove and the tank wall and seal the tank wall and opening to the oil cooler fitting.

21. An oil cooler for use in a tank of a motor vehicle radiator having at least one plate assembly comprising a pair of plate shells, each plate shell having opposite upstanding walls, with one plate shell having a smaller width between upstanding walls than the other plate shell, the plate shells being nested so that the upstanding walls are in contact and sealed along peripheries of the shells to form an interior space therebetween, the width of the plate assembly being equal to the width of the shell having the larger distance over the plate shell upstanding walls.

22. The oil cooler of claim 21 wherein the oil cooler is made of stainless steel.

23. The oil cooler of claim 21 wherein the width of the plate assembly is from about 25 to 34 mm.

24. The oil cooler of claim 21 having a plurality of plate assemblies spaced apart from each other by at least 3 mm.

25. A heat exchanger assembly comprising:
an oil cooler having fittings thereon for passage of oil into and out of the oil cooler; and
a heat exchanger tank having front and rear walls, with openings in one tank wall through which the oil cooler fittings pass,
the oil cooler being mounted within the tank so that the oil cooler is located approximately equidistant from the front and rear tank walls.

26. The heat exchanger assembly of claim 25 wherein the oil cooler is located at least about 12 mm from each of the tank walls.
